(19) United States
(12) Patent Application Publication
(10) Pub. No.: US 2005/0104737 A1
(43) Pub. Date: May 19, 2005

(54) Safety system

(76) Inventor: Nigel George Woodward, Lakeside Village (ZA)

Correspondence Address: CHRISTIE, PARKER & HALE, LLP, PO BOX 7068, PASADENA, CA, 91109-7068, US

(21) Appl. No.: 10/507,657

(22) PCT Filed: Sep. 20, 2002
(86) PCT No.: PCT/IB02/03870

(30) Foreign Application Priority Data
Mar. 13, 2002 (ZA) 2002/2057

(51) Int. Cl. G08B 3/00

(52) U.S. Cl. 340/691.1

(57) ABSTRACT

A safety system including an event sensor (6), a source (7) of non-toxic and non-flammable alarm gas, and control means to release the alarm gas in response to a signal received from the event sensor (6) in response to the occurrence of a predeterminable event (8). The invention also disclose a method for operating a safety system in an underground mine (1).

### FIELD OF THE INVENTION

This invention relates to a safety system, in particular but not limited to, an underground mine safety system.

### BACKGROUND TO THE INVENTION

One of the main concerns in underground mining operations is the safety of miners. Serious threats to the safety of miners include the presence of gases, the occurrence of earth tremors, and the breakout of fires in mine development ends and passageways.

Mine personnel frequently work in passages that branch out from main hauling ways, typically up to 1000 m meters away. If a fire breaks out in a main hauling way the miners at the work face have to rely on someone else warning them in time to evacuate. In addition, conventional alarms are often not heard because miners have to wear hearing protection against the intense noise of mining operations.

It is therefore not always possible for miners to see a visual alarm system such as a flashing light, or to hear a siren when an alarm is activated.

For the same reasons the reaction time of ground level emergency teams are also often delayed.

It could also happen that miners are exposed to noxious and flammable gases such as methane or carbon monoxide that could lead to injury or death of the miners. It is desirable that miners be warned as soon as possible about the presence of such gases.

One type of existing warning system is the so-called “stench gas” warning system. This system uses an extremely unpleasant gas to warn miners of imminent danger. The particular gas is unpleasant to the point of being nauseating.

In the event of fire or other emergency the stench gas is introduced into the main ventilation system of the mine from where it spreads through the entire mine.

This has several disadvantages, which in many instances have led to resistance to its use. One disadvantage is that the stench gas spreads through the entire mine, or at least a substantial part of it. Once the particular event has been taken care of the workers have to wait until the unpleasant gas has dissipated before they can resume work. This obviously leads to loss of otherwise production time.

Another bigger problem is that in some instances the gas causes nausea which may lead to vomiting. If a miner is in a smoky environment where he has to rely on breathing apparatus to pass through or survive in, vomiting may force him to remove his mask. This exposes him to the smoke which he was trying to avoid in the first place.

Another disadvantage is that the warning effect of the stench gas system is dependent on the flow of air through the ventilation system of the mine. It is possible, and in some instances most likely, that for example smoke from a fire will reach miners at a workplace before the stench gas will reach them. This makes the stench gas warning system ineffective in such a case. The same is true for other toxic gases.

In the event of a small fire in a remote part of a mine the release of stench gas into the ventilation system will cause the entire mine, or at least a substantial part of it, to be evacuated. This results in unnecessary loss of productive time if the fire can be handled efficiently enough to not warrant closure of the entire mine.

There are also other instances where it is also difficult or impossible for people to react in time to a visual or auditory alarm system. An example of this is old age homes where there are usually people with poor hearing or eyesight, or both. Other examples include facilities for the care the deaf, blind or otherwise physically impaired people.

Another existing type of warming system is that which is disclosed by French patent 2811117. The invention disclosed in this patent relates to a warning system for emergency workers who respond to, for example, accident scenes. With some accidents trucks carrying hazardous cargo may pose a danger to people.

When emergency workers respond to such a site it often happens that the hazardous contents notifications are out of sight or blackened from a fire.

The system disclosed by French patent 2811117 uses, amongst other identifiers, coloured gas to distinguish between various types of cargo. In the event of an accident the coloured gas is released to provide a visual indication of the type of cargo in the vehicle. The system may also be secured to a container.

### OBJECT OF THE INVENTION

It is an object of this invention to provide a safety system that at least partly alleviates some of the abovementioned problems.

### SUMMARY OF THE INVENTION

In accordance with this invention there is provided a safety system comprising at least one event sensor, a source of pressurized non-toxic and non-flammable fragranced alarm gas, and control means to release te alarm gas in response to a signal received from the event sensor in response to the occurrence of a predeterminable event.

There is also provided for the event sensor to be remotely located from the source of pressurized gas and for the signal sent from the event sensor to be distinctive of the event that triggered the event sensor.

There is further provided for the source of pressurised gas to be located intermediate a mine working face and the event sensor.

There is also provided for the event sensor to comprise at least one of a gas sensor, an earth timer sensor; and a temperature sensor, and for the signal from the event sensor to be indicative of the type of event.

The invention further provides for the event sensor to include at least one gas sensor, preferably multiple gas sensors, and for the signal sent from the at least one gas sensor to be indicative of the type of gas sensed.

There is further provided for the signal to be Indicative of respectively a gas concentration, a magnitude of an earth tremor sensed, or a temperature reading of the event sensor environment.

The invention also provides for the event sensor to require sensing of an event for a predeterminable time, alternatively for a predeterminable level of the event to be sensed, further alternatively for a predeterminable level of the event to be sensed for a predeterminable time, before a signal is sent to the control means.

There is further provided for the source of alarm gas to be a pressurized gas container, for the control means to include an electrically actuated valve in the container, and for the control means to include an electricity supply for the valve.

There is further provided for the alarm gas to be pressurizable by means of nitrogen gas, and for the alarm gas to be citrus fragranced.

There is further provided for the alarm gas to be released into the intake airflow system of a mine and for the alarm gas to be carried by the airflow to a working face of the mine.

There is further provided for the event sensor to transmit the signal to the control means by means of a fixed time connection, alternatively wireless communication including radio waves, microwaves and infrared waves.

The invention also provides for the safety system to include a siren and an alarm light and for the control means to activate the siren and alarm light in addition to releasing the alarm gas in response to the signal received from the event sensor.

The invention also provides for a signal from the event sensor to be receivable by a remote control station and for the remote control station to be located on surface level.

The invention also provides for a method of operating a safety system including the steps of:
a. Installing at least one event sensor in a first predeterminable area;
b. Installing a source of pressurized non-toxic and non-flammable fragranced alarm gas in a second predeterminable area;
c. Transmitting a signal from the event sensor to control means associated with the pressurised gas container upon sensing of a predeterminable event in the first area.
d. Releasing alarm gas into the second area upon reception of the signal.

There is also provided for the first area to be a mine passage way and the second area to be proximate a mine working face.

There is further provided for the method to include the step of releasing the alarm gas in the intake airflow of the mine proximate the mine working face.

There is also provided for the method to include the step maintaining a predetermined maximum distance between the source of pressurised gas and the mine working face.

There is further provide for the method to include the step of installing additional pressurised gas containers upon progression of the mine working face, alternatively for relocation the already installed sources of pressurised gas to maintain the predetermined maximum distance between the source of pressurised gas and the mine working face.

There is still further provided for the method to include the step of each event sensor transmitting an alarm signal across a predeterminable range.

There is further provided for each alarm signal to also be transmitted to a remotely control station.

### BRIEF DESCRIPTION OF THE DRAWINGS

An embodiment of the invention will be described below by way of example only and with reference to the accompanying diagrammatic drawings in which:

FIG. 1 is a plan view of a mine in which a safety system has been installed.

FIG. 2 is a part sectional elevation of a housing for a pressurised gas container.

### DETAILED DESCRIPTION OF THE DRAWINGS

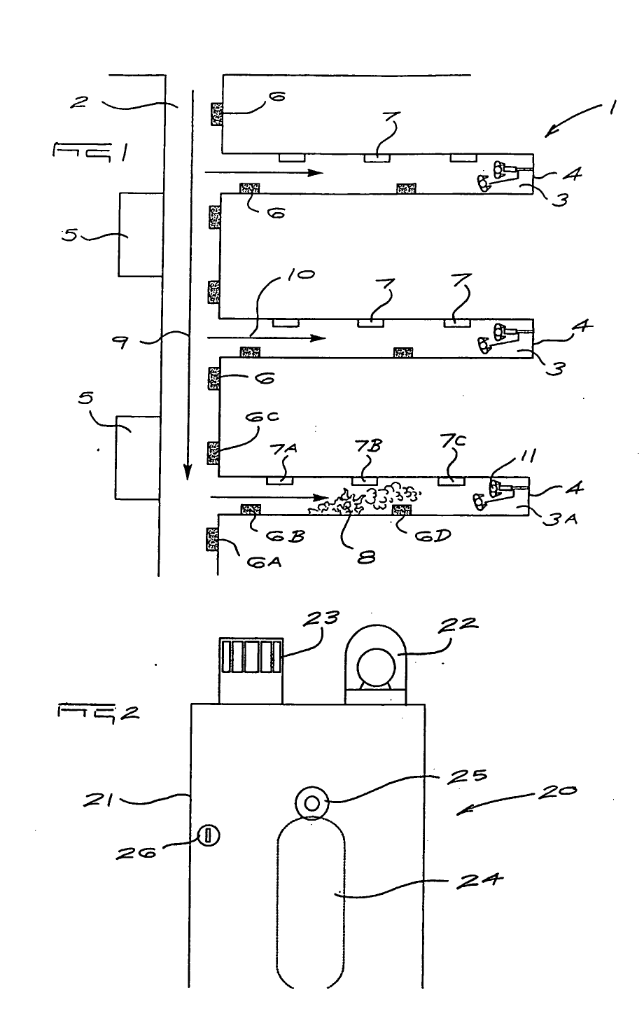

In the embodiment of the invention shown in FIG. 1 a plan view of a mine (1) is shown. The mine (1) includes a main hauling way (2) and several mine development ends (3). Each development end provides a stope working face (4) at which miners excavates rock. The length of a development end (3) can typically be in the order of about 1000 m.

The mine is ventilated through an air intake flow system (not shown). Air (9) is forced through the mine workings in the system and down (10) the development ends until it reaches the working faces (4).

In the main hauling way (2) there are several refuge bays (5) to which miners can retreat in case of emergency. Also in the main hauling way and in the development ends there are several event sensors (6) and sources of pressurized gas (7). The event sensors (6a, 6b, 6c, 6d) in a specific area are linked by means of electrical cable to specific sources of pressurized gas (7a, 7b, 7c) in that vicinity. The sources (7a, 7b, 7c) are chosen to be in a predetermined range from the event sensors (6a, 6b, 5c, 6d) and also to be in the direction of airflow from the event sensors (6a, 6b, 6c, 6d). This is done to ensure that any area that could be effected by smoke spreading with the airflow is warned in time about the danger.

In the event of for example a fire (8) in the hauling way (2) smoke from the fire will travel down the hauling way (2) and enter at least development end 3a, from where the airflow from the air intake flow system will carry the smoke (not shown) towards the working face (4). Once the smoke reaches the working face (4) the miners (11), if not warned in time, will have to don their safety gear a walk back towards the refuge bays through the smoke and possibly through the spreading fire (8).

The event sensors (6a, 6b, 6c) proximate the entrance to the development end (3a) will sense the smoke and if it senses the smoke for more than the preset 20 seconds, it will send a signal to the linked gas sources (7a, 7b, 7c) and the ground level control room (not shown).

Upon receipt of the signal the control means in the linked gas sources (7a, 7b, 7c) will open the pressurized gas containers (not shown) to release citrus scented nitrogen gas, which is both non-toxic and non-flammable, into the airflow of the intake air flow system of the mine. The citrus scented gas will be transported by the airflow until it reaches the workface. As soon as the miners smell the citrus scented gas they will realize that an alarm has been triggered. They then have the opportunity to don their safety gear and walk back towards the refuge bays (5) in the hauling way (2).

Detail of an alarm unit (20) for a pressurized gas source is shown in FIG. 2. It shows a metal box (21) that is mountable to a wall of a mine development end (3). The box (21) includes a conventional alarm light (22) and audible siren (23). A container (24) with pressurized gas therein is secured inside the alarm unit (20). The gas container (24) has an outlet (25) that extends through the alarm unit outer cover (not shown) to enable the gas to be released outside the unit (20). The unit (20) has a lock (26) to prevent tampering with the equipment.

It will be apparent to those skilled in the art that this has the advantage that the miners at the workface are alerted within just more than 20 seconds of the occurrence of an event that requires evacuation. This in contrast to what is currently the case where several critical minutes, or even longer, may pass without the miners knowing about the event. Indeed, it often happens that miners only become aware of an event once they smell the smoke at the work face. It has been established in trials that the citrus scented gas can be smelled up to as much as 600 m away from its source.

The same applies for the presence of noxious gases where miners would only become aware of the presence of the gases when other portable gas detection instruments they carry warns them of the presence of such gases. In the same manner miners can be warned of an earth tremor in another part of the mine which would also increase the time they have to react or of possibly dangerous rise in temperature in an area of the mine.

As mentioned before the event sensors (6a, 6b, 6c) also send their signals to a ground level control room. The control room will have the ability to immediately identify the type of event (fire, type of noxious gas, earth tremor, environment temperature), the magnitude of the event (gas concentration, magnitude of the tremor on for instance the Richter scale, specific temperature), and the distribution of the event (from the number and spread of event sensors sending signals) as well as the spread of the for instance a fire (by following the sequence in which event sensors send signals). This will enable the control room to take the most appropriate action to combat the event, which could also save lives, focuses the action to the appropriate area and avoids unnecessary disruptions to unaffected areas.

As the normal mining operations continue the gas sources (7) can be moved along the development end to remain in close proximity to the working face, or preferably new gas sources can be installed once the working face has moved a predetermined distance (which should be less than the distance of about 600 m over which the citrus scented gas can reliably be smelled).

It will also be clear that this allows a gas warning to be sent to the mine workers at a working face that will not cause them to become nauseas and possibly vomit. This is extremely unpleasant for the successful evacuation of the mine in which miners have to wear breathing apparatus and pass through thick smoke.

Part of the control of the mine includes temperature sensing in the passages. By sensing the temperature of the environment dose to the miners it is possible to react quicker to a dangerous rise in temperature in this environment.

It will be understood that this is only one embodiment of the invention. It is possible to alter some aspects of the embodiment without departing from the scope of the invention.

It is for instance possible to install a similar system in an old age home where there are normally people who have either poor hearing or eyesight or both. By using smell as an alarm signal the probability of the people reacting to an alarm in time increases. Similar systems could also be installed in other care facilities, in domestic homes, restaurants, and offices. In all of these locations the installation of the safety system will at least increase the probability of people reacting to an alarm in time.

1-34. (canceled)

35. A safety system comprising at least one event sensor, a source of non-toxic and non-flammable alarm gas, and control means to release the alarm gas in response to a signal received from the event sensor in response to the occurrence of an anticipated event, characterised in that the alarm gas is fragranced and the gas is releasable into an enclosed area.

36. A safety system as claimed in claim 35 in which the enclosed area comprises at least part of a mine.

37. A safety system as claimed in claim 36 in which the alarm gas is releasable into an intake airflow system of the mine to be carded by the airflow to a working face of the mine.

38. A safety system as claimed in claim 35 in which the enclosed area comprises at least part of a building.

39. A safety system as claimed in claim 35 in which the alarm gas has a citrus fragrance.

40. A safety system as claimed in claim 39 in which the event sensor is remotely located from the source of the alarm gas.

41. A safety system as claimed in claim 40 in which the signal sent from the event sensor is indicative of the event that triggered the event sensor.

42. A safety system as claimed in claim 41 in which the event sensor includes at least one of a gas sensor, an earth tremor sensor, and a temperature sensor.

43. A safety system as claimed in claim 42 in which the signal sent from the event sensor is indicative of the type of event.

44. A safety system as claimed in claim 43 in which the signal sent from the gas sensor is indicative of a type of gas sensed.

45. A safety system as claimed in claim 44 in which the signal sent from the gas sensor is indicative of a gas concentration sensed by the event sensor.

46. A safety system as claimed in claim 45 in which the signal from the earth tremor sensor is indicative of a magnitude of an earth tremor sensed.

47. A safety system as claimed in claim 46 in which the signal sent from the temperature sensor is indicative of a temperature reading of the event sensor environment.

48. A safety system as claimed in claim 47 in which an event has to be sensed for a predeterminable time before the signal is sent to the control means.

49. A safety system as claimed in claims 47 in which a predeterminable level of an event has to be sensed before the signal is sent to the control means.

50. A safety system as claimed in claim 47 in which a predeterminable level of an event has to be sensed for a predeterminable time before the signal is sent to the control means.

51. A safety system as claimed in claim 50 in which the source of gas is a pressurizable container.
